(19) United States
(12) Patent Application Publication
(10) Pub. No.: US 2014/0081815 A1
(43) Pub. Date: Mar. 20, 2014

(54) Process and System for Synchronizing Data From a Meter Collection Database to a Billing Database

(71) Applicant: Joe Miller, Berlin, CT (US)

(72) Inventor: Joe Miller, Berlin, CT (US)

(21) Appl. No.: 14/031,416

(22) Filed: Sep. 19, 2013

Related U.S. Application Data
(60) Provisional application No. 61/703,419, filed on Sep. 20, 2012.
(60) Provisional application No. 61/710,148, filed on Oct. 5, 2012.

(51) Int. Cl. G06Q 30/04

(52) U.S. Cl. CPC G06Q 30/04
USPC 705/34

(57) ABSTRACT

There is provided a synchronization procedure built to gather customer multi-function printer (MFP) usage and to verify and aggregate gathered data and associate it with a customer and child sites associated with the customer. The aim of this procedure is to ensure that the client has been billed/credited properly and the services provider receives the monies that it is due.

### CROSS-REFERENCE TO RELATED APPLICATION(S)

The instant application claims the benefit of U.S. Provisional Patent Application Ser. No. 61/703,419, filed Sep. 20, 2012, entitled CONTRACT PAGE RECONCILIATION PROCESS, and U.S. Provisional Patent Application Ser. No. 61/710,148, filed Oct. 5, 2012, entitled PROCESS AND SYSTEM FOR SYNCHRONIZING DATA FROM A METER COLLECTION DATABASE TO A BILLING DATABASE.

### BACKGROUND

The present disclosure relates to a process and system for synchronizing the data from a meter collection database to a billing database.

The present invention also relates to a contract page reconciliation (overage) process and system.

A contract reconciliation is used to manage contract page reconciliation bills over the life of a contract for page per copy contracts. The program consists of conciliating the actual pages printed against the contracted pages for a billing period. If the printed pages for the period are greater than the contracted pages, an overage bill is created. If the printed pages are less than the contracted pages and credits are allowed in the contract a credit to the customer is created.

### SUMMARY

In accordance with the instant disclosure, there is provided a process for reconciling and billing cost per copy contracts, which process broadly comprises the steps of: electronically creating a cost per page contract; electronically collecting information from meters on devices covered by said contract; calculating pages printed by each said device from said collected information for a billing period; comparing calculated printed pages to contracted pages for said billing period; determining if usage is an overage or an underage; and creating an invoice if said usage is an overage or creating a credit if said usage is an underage.

In another and alternative embodiment, the contract creating step comprises inputting start and end dates and inputting a billing frequency.

In another and alternative embodiment, the contract creating step comprises entering pricing information and a number of allotted pages for the billing period.

In another and alternative embodiment, the process further comprises entering information about non-billable meters and devices as exceptions to the contract.

In another and alternative embodiment, the collecting information from said meters comprises establishing a baseline meter reading for each said device.

In another and alternative embodiment, the collecting information from said meters further comprises reading the meters on said contracted devices at a predetermined interval.

In another and alternative embodiment, the process further comprises calculating an adjusted reading for each said meter which is a projected meter reading for a day that payment of an invoice would be due.

In another and alternative embodiment, the calculating step comprises subtracting a number of pages on a previous invoice from said adjusted reading.

In another and alternative embodiment, the process further comprises electronically transmitting said invoice to a customer for approval.

In another and alternative embodiment, the process further comprises designating said invoice as approved if said customer does not approve said invoice within a predetermined period.

In another and alternative embodiment, the process further comprises posting said transmitted invoice to a general ledger in a memory when said invoice is designated as approved.

In another and alternative embodiment, the process further comprises electronically transmitting said invoice to said customer for payment.

Further in accordance with the present disclosure, there is provided a process for synchronizing data from a meter collection database to a billing database, which process broadly comprises the steps of: retrieving a meter value from a device and transmitting the retrieved meter value to a database; reviewing identifiers associated with the device to determine if the device is a pre-existing device or a new device; reviewing the meter value to determine that the meter value is valid; saving said meter value to a meter ledger in said database; and electronically transmitting said meter value to a billing ledger.

In another and alternative embodiment, the identifier reviewing step comprises determining that a customer and a location of said device are active.

In another and alternative embodiment, the identifier reviewing step comprises filtering the data to determine that the device is a known model.

In another and alternative embodiment, the identifier reviewing step comprises filtering the data to check for customer specific exclusions.

In another and alternative embodiment, the identifier reviewing step comprises processing the device as new unless found to be an existing device.

In another and alternative embodiment, the process further comprises creating a new record in said database if said device is determined to be new.

In another and alternative embodiment, the process further comprises retrieving data from each said meter for the last six months.

In another and alternative embodiment, the saving step comprises reviewing all meters in said database until all are saved to said meter ledger.

In another and alternative embodiment, the process further comprises marking a record for review if a meter value is determined to be invalid or suspect.

In another and alternative embodiment, the process further comprises electronically generating an invoice for a customer.

In another and alternative embodiment, the invoice generating step comprises using information only from verified valid meters.

Further in accordance with the present disclosure, there is provided a system for synchronizing data from a meter collection database to a billing database which broadly comprises: a plurality of devices having a meter; connecting said devices to a processor having a database; each said device transmitting a meter value to said database; said processor having means for reviewing identifiers associated with the device to determine if the device is a pre-existing device or a new device, means for reviewing the meter value to determine that the meter value is valid, and means for saving said meter value to a meter ledger in said database; and a billing ledger for generating invoices to customers, said billing ledger receiving information from said meter ledger.

Other details of the contract page reconciliation process and the system and process for synchronizing the data from the meter collection database to a billing database are set forth in the following figures in which like reference numerals depict like elements.

### DETAILED DESCRIPTION OF THE DRAWINGS

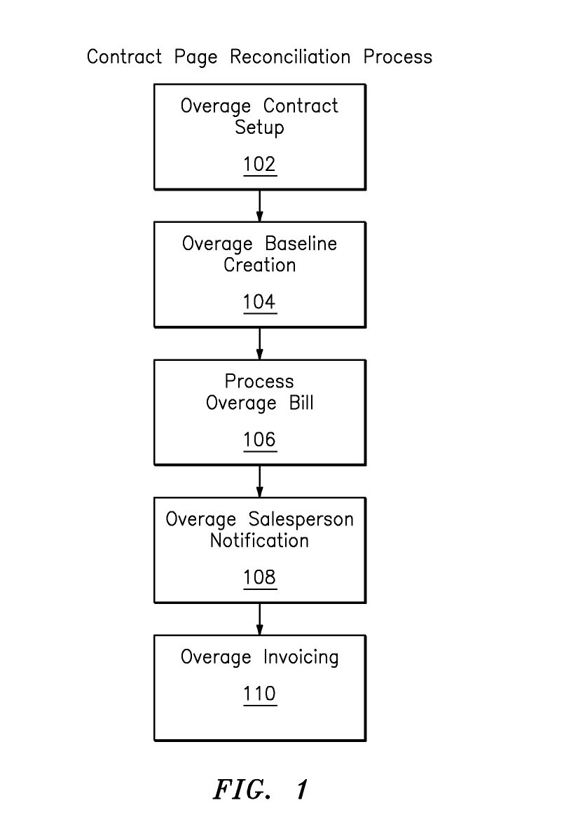

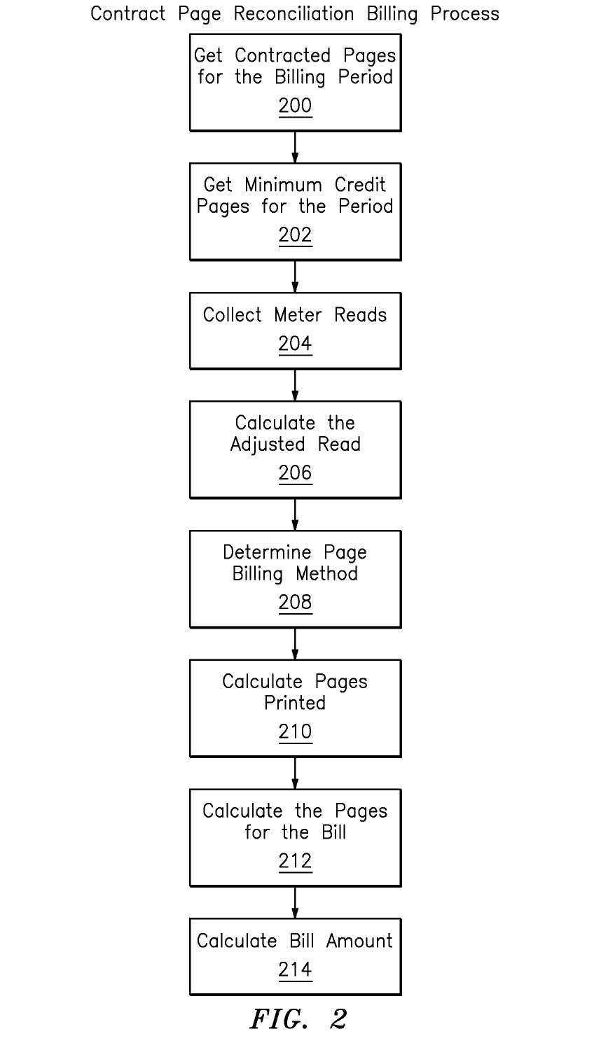

FIG. 1 illustrates the overall workflow steps for the contract page reconciliation process;

FIG. 2 illustrates the workflow steps in detail of the contract page reconciliation billing process;

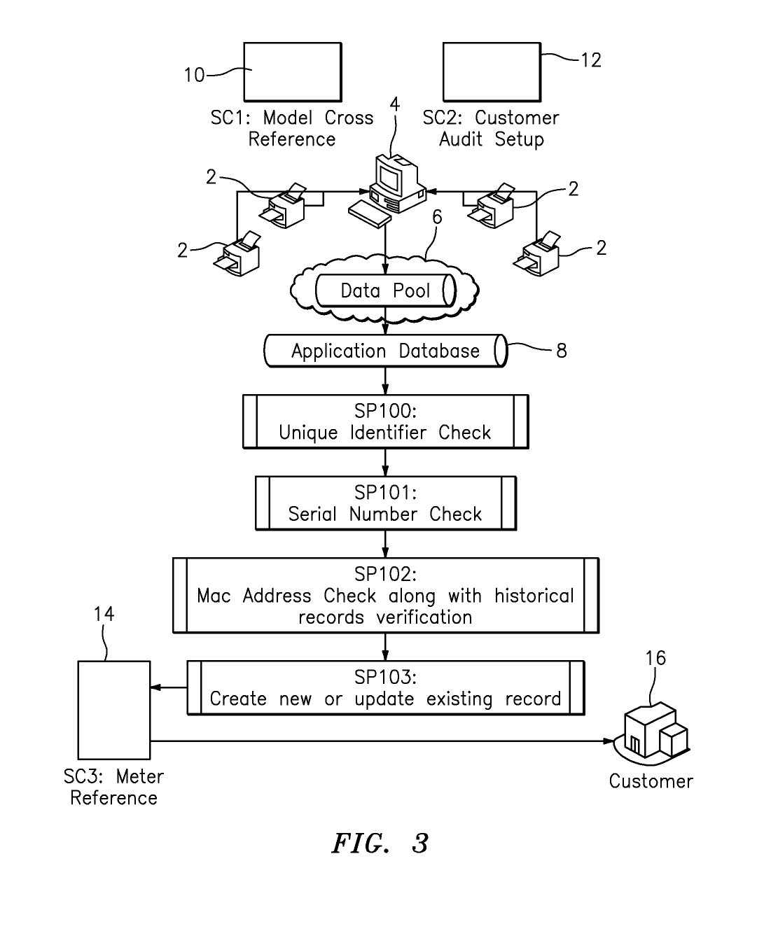

FIG. 3 is a schematic representation of the overall system for synchronizing the data from the meter collection database to a billing database; and

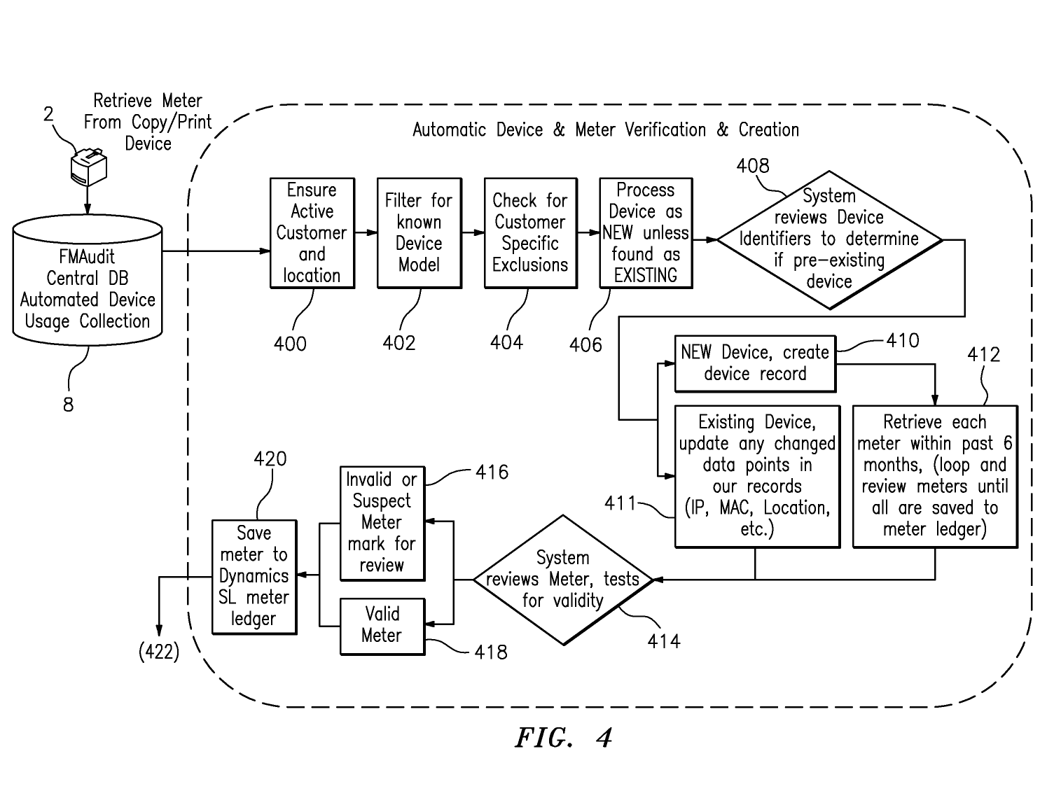

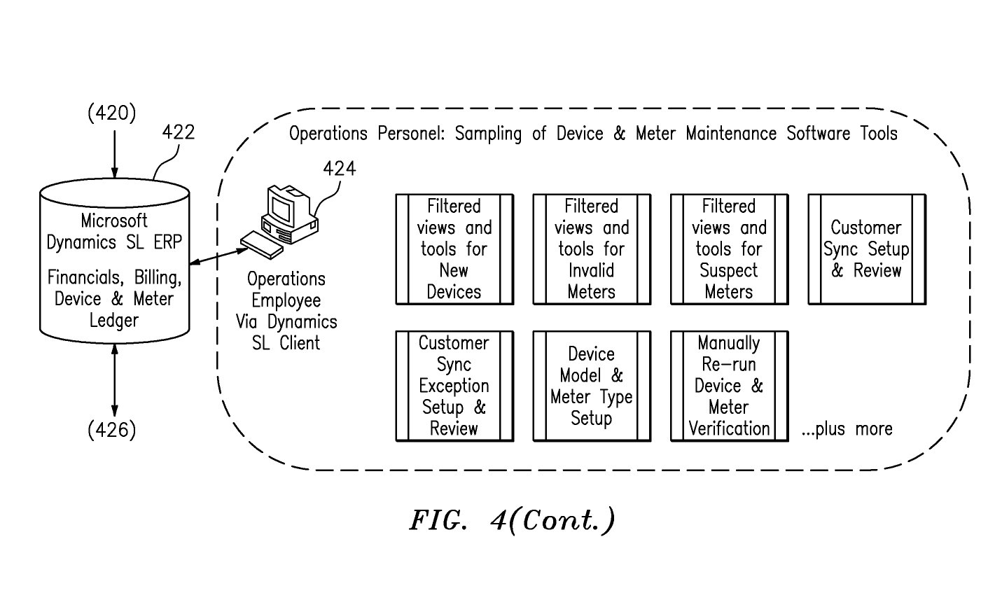

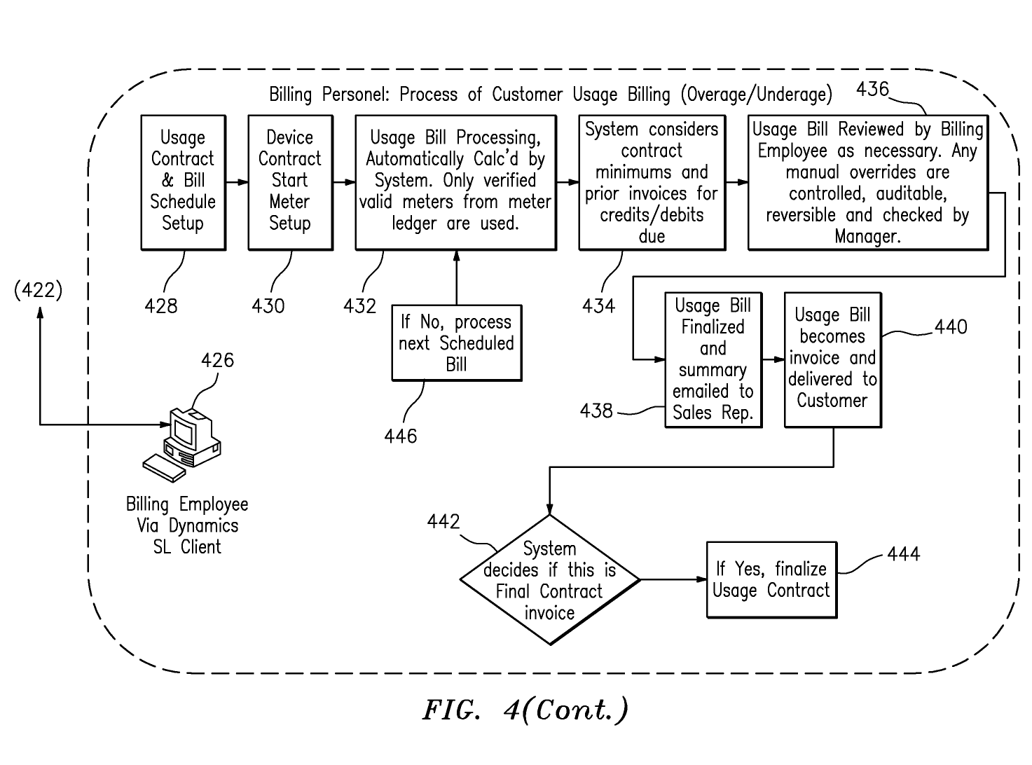

FIG. 4 is a schematic representation of a process for synchronizing the data from a meter collection database to a billing database.

### DETAILED DESCRIPTION

Referring now to FIG. 1, there is illustrated the workflow steps of a process for reconciling and billing cost per copy contracts. The process is a page reconciliation process when used in connection with the activities of at least one cost per copy contract.

In step 102, the cost per page contract is setup electronically on a computer or other device such as an Ipad. Contract start and end dates are electronically inputted or entered into the contract and a billing frequency is selected and electronically entered or inputted into the contract. Available billing frequencies are monthly, quarterly, semi-Annually, annually, and end of contract. Once a billing frequency is selected, bills can be electronically created. Pricing information and contracted/allotted pages are also electronically entered or inputted into the contract. Non-billable meters and devices are electronically entered or inputted into a database on a server as exceptions for the contract. When completed the cost per copy contract may be stored in a database on a server

Step 104 establishes a baseline meter reading for the cost per page contract. In this step, information from the meters on each device under contract is collected and stored in a database on the server. The meter readings may be collected electronically via a telephone line and/or a wireless transmission system at predetermined intervals. The baseline meter reading is the starting page count (meter read) for each device under the contract. The baseline meter reading is crucial to calculating the pages printed on the first bill.

In step 106, the cost per copy bill is processed electronically. During the billing process period, the meters for the devices under contract are collected electronically for the selected billing period. Logic may be applied by a pre-programmed computer to calculate an adjusted meter reading which is a projected meter reading for the day payment of the bill is due. The adjusted meter reading may be stored in the database on the server. The pages printed for the bill being prepared may be calculated by subtracting the adjusted meter reading from the previous bill pages printed if there is a previous bill. If no previous bill is found then the baseline is used to calculate the pages printed for the bill. The amount to charge for the bill is calculated by multiplying the price per overage/price per credit. The billing method will be explained in more detail in FIG. 2.

Once the billing amount is calculated, the process moves to step 108. In step 108, bills are sent to the customer's respective salesperson for approval. The bills may be sent electronically or in paper form. If the bill does not get approved by the salesperson after a predetermined period, such as 3 working days, the bill will automatically move to approval status and stored in the database in a memory. Once the bill is in approval status, the process moves to step 110 for bill invoicing.

In step 110, the bill is selected for invoicing. Several checks are executed to ensure that all the equipment in the bill is ready for invoicing. The process at this point looks for devices not under contract, devices that have been merged into other devices, and duplicate devices found in the system. The invoice then gets processed, batch numbers and reference numbers are created and the bill is electronically outputted to a user's computer screen or other device screen for review. Once the bill is reviewed, the user has the option to keep or delete the invoice. If the user keeps the invoice, the invoice data gets posted to a general ledger transaction table in an ERP (WHAT IS ERP?) system. If the user deletes the invoice, the invoice data gets deleted and the invoice is set back to approval status so it is ready for invoicing again.

Referring now to FIG. 2, there is shown the process performed by contract pages reconciliation billing process in more detail. The purpose of the billing process is to calculate the pages printed for each device under contract. If the pages printed for all the devices are greater than the contracted pages, then an overage bill is created. If the pages printed for the period is less than the contracted pages for the period and the contract is setup to allow credits, then a credit invoice is created.

The contract pages reconciliation billing process starts in step 200 where the contracted pages for the period are calculated using the technique described hereinabove. The monthly contracted pages are multiplied by the numbers of months in the billing period. For example, if the contract is created for 1000 pages a month and the billing period is quarterly (three months), then the contracted pages equals (1000*3).

The process then moves to step 202 and calculates the minimum credit pages for the period. Minimum credit pages are the number of pages allowed to credit. If the customer prints less pages than the contracted amount for the period, then pages are credited up to the minimum credit limit. For example, if the customer prints 500 pages in a billing period, the contracted pages are 1000, and the minimum credit allowed is 250, then the customer will get a credit for 250 pages not the whole 500 pages remaining.

The process moves to step 204 to electronically collect meter reads for all the devices under contract. The process attempts to find the meter closest to the bill's due date in the database where the meter reads are stored. The process may first look for readings in the database that are within 60 days from the bill date. If readings are not found after the bill date, the process will look in the database for meter reads 30 days prior to the bill date. The process will ensure that there are at least 14 days between the meter readings on the devices.

Next the process moves to step 206 to calculate the Adjusted meter reading. As noted before, the adjusted meter reading is the projected meter reading on the day payment of the bill is due. If the bill is due in January and we have a reading that is 3 months newer, then the process will attempt to project the reading back to what it would have been in January. The following logic may be used to calculate the adjusted read:
A valid reading found after the bill date

Adjusted read=reading−(Daily Average*number of days between reads.
A valid reading found before the bill date

Adjusted read=Reading+(Daily average*numbers of days between reads)
Don't have a valid reading but the device was on the previous bill

Adjusted read=Prior bill adjusted Read+(Daily average*number of days since prior bill)
Don't have a valid reading and the device was not in the prior bill

We assume it is a new device and the adjusted read=1

Next the contract page reconciliation billing process moves to step 208 to determine what billing method to apply. The page billing method is the type of average used to calculate the device's bill pages. The process will go down the list below as a hierarchy and apply the billing method that meets the criteria. The following are the billing methods implemented:
Actual—The actual average for the period based on two valid meter readings
Contract—The average for the series as defined on the contract
Prior Bill—The average that was used for the device on the previous bill
Historical—The device's historical average based on ALL readings
Site—The average for all like devices at the site
Customer—The average for all like devices across all of the customer's sites
FloTech—Flo-Tech's defined average for the series.

Next the process moves to step 210 to calculate the actual pages printed for each device in the contract for the billing period. Once the adjusted reading is calculated using a calculation program stored on a computer/server, the following logic may be applied to calculate the pages printed for the period:
If a reading for the period was found and the devise was in the previous bill

Pages Printed=Current Adjusted Reading−Prior Period's Adjusted Reading
If a reading was not found for the period and the device was in the previous bill

Pages Printed=Prior Period's Adjusted Reading+(((Daily Average*365)/12)*Nbr of Months in Period)
If a reading was found for the current period and the device was not in the previous bill
   If the reading for the current period is less than the monthly device volume*2

Pages Printed=(((Daily Average*365)/12)
*Nbr of months in period)
If the reading for the current period is greater than the monthly device volume*2

Pages Printed=(((Daily Average*365)/12)
*Nbr of months in period)*number of bills)
If a reading for the current period was not found and the device was not in the previous bill

Pages Printed=Prior Period's Adjusted Reading+(((Daily Average*365)/12)*Nbr of Months in Period)

Next the billing process moves to step 212 to calculate the actual pages for the billing period. Actual pages printed are calculated by: Pages printed for the period−contracted pages for the period. If the actual pages are greater than 0, then it is an overage bill. If the pages printed are less than 0 and credits are allowed for the customer, then it is a credit bill to the customer.

Next the process moves to step 214 to allow the computer/server to calculate the bill amount. Bill amount is the multiplication of the actual pages by the price per page depending if the bill is an overage or a credit.

Referring now to FIG. 3, there is shown a system for synchronizing data from a meter collection database to a billing database. One can see from FIG. 3, the system comprises a plurality of printers/copiers 2 linked to a computer/server 4. The links may be telephone or computer links for transmitting information from meters on the printers/copiers 2 to the computer/server 4. The information received by the computer/server 4 are stored in a memory or a database 6 entitled Data Pool which is associated with an application database 8.

After gathering raw customer data, the data is scrubbed to ensure that the services provider is receiving and storing accurate and clean data in the Data Pool 6. The scrubbing process may be carried out in any desired manner. For example, the computer/server 4 may run a scrubbing algorithm.

The initial step of this synchronization procedure, before actually diving into the data, is to ensure that the system is mapped correctly to allow for the incoming data to be associated with equipment model information in the system. The mappings themselves are managed through a custom maintenance screen SC1 10.

After verifying that the mapping is correct, the procedure moves on to customer exclusions which are managed on an SC2 12 maintenance screen. These portions of the procedure watches for predefined flags associated with the customer equipment, allowing the procedure to execute an action, whether it is to ignore this record or proceed forward with the data aggregation.

In SP100, the computer/server 4 is looking for a possible match in the system for the incoming record. This is a multistep process starting with a match of unique identifiers between the system and the incoming dataset. If there is no match between the unique identifiers and the incoming data, the procedure moves to a next sweep which involves the equipment serials numbers.

Step SP101 performs the match between the equipment serial numbers in the database and the incoming dataset. If no match is made, the procedure moves to the next check which is the equipment machine access control address (MAC).

In Step SP102, the process performs the equipment machine access control address check. This process is more involved. If a match is made, the match is verified to make sure it is consistent with the historical system data. To accomplish, a particular subroutine is launched in the computer/server 4. The subroutine uses the matched equipment data along with information from the incoming dataset to determine if the match is historically viable. If this routine returns a false result, the match is cleared and the process proceeds on.

In Step SP103, after the extensive verification process, it is determined whether this equipment is a “new” device of an “existing” piece of equipment. The main differences in the actions that follow are that one path will update an existing piece of equipment's information while the other creates a new record and appends the gathered data. In addition, with new devices an effort is made to ensure that the data is accurate. This is done by another subroutine run by the computer/server 4 which goes back into the historical Data Pool and collects record sets that belong to this equipment and put not only the new record but six months, if available, worth of its previous recorded data into the system.

The SC1 model cross reference 10 is an application that allows one to map new models with devices in the database to ensure proper allocation. This application empowers the user with the ability to look through and maintain existing mappings along with establishing new ones.

The SC2 customer audit setup 12 is an application where a user creates a mapping between the system and a third party system's database creating a unique identification (ID) connecting both together. This application empowers the user with filtering capabilities that allow one to be able to control the flow of data into different “sites” per customer. Also this application provides the tools that allow the user to exclude devices from being recorded.

If there are no exclusions and the mapping is correct, the equipment “true up” begins. By the term “true up”, it is meant that an overage/underage bill is processed for a customer. For instance, if one prints 100 pages a month, at the end of the first quarter, it is seen whether the customer has printed 300 pages. If not, the books or records are adjusted so that if more than 300 pages have been printed, the customer gets an overage bill. If only 250 pages have been printed, the customer receives an underage credit.

After the information has been verified and the matches identified, the next step is the SC3 contract overage meter reference 14. This is an application that allows a user to review meter information for all customers, contracted or non-contracted. This application empowers the user with tools and filters to drill in to the customer data and find anomalies and flag them if needed. With this tool, the users can view equipment in any state of its lifecycle including retired or inactive equipment. Along with the ability to capture data snap shots within date ranges to assist in the verification of customer records. All of these steps ensure that the customer 16 will be correctly billed for its usage. Once all the steps have been performed, an overage bill or an underage credit may be sent to the customer 16.

Referring now to FIG. 4, the process for synchronizing the data from a meter collection database to a billing database is illustrated in flow chart form. In an initial step, the meter value is electronically retrieved from the copy/print device 2 and information is electronically sent to the audit central database 8.

In the following steps of the process, identifiers associated with each device are reviewed to determine if each of the devices is a pre-existing device or a new device. For example, in step 400, the user ensures that the customer is active and notes the customer's location. In step 402, the data is filtered to determine whether the device is a known device model. In step 404, the data is checked for customer specific exclusions. In step 406, the device is processed as being new unless it is found to be an existing device. In step 408, the system reviews the device identifiers to determine if it is a pre-existing device. If it is determined that the device is a new device, in step 410, a device record is created.

In step 412, data is retrieved for each meter within the past 6 months. In this step, the review consists of a loop and review of all meters in the database until all are saved to a meter ledger. In step 414, the system reviews meter data and tests for validity. For example, if in step 408, it is determined that the device is an existing device, then in step 411, the database is updated to reflect any changed data points (IP, MAC, location, etc.). Once step 411 has been performed, then as before, in step 414, the system reviews the meter data and tests it for validity. As can be seen from steps 416 and 418 respectively, the system determines whether the meter is an invalid or suspect meter and marks the record for review (step 416) or whether the meter is a valid meter (step 418). In step 420, the meter data is saved to the dynamics SL meter ledger in the computer/server 422.

The computer/server 422, in addition to having a meter ledger, has databases with financial information, billing information, and device information. The computer/server 422 may be connected to an operations employee via dynamic SL client computer/server 424 and to a billing employee via dynamics SL client computer/server 426.

The information in the computer/server 422 may be used to provide device sampling and meter maintenance software tools for operations personnel. For example, the computer/server may provide: filtered views and tools for new devices; filtered views and tools for invalid meters; filtered views and tools for suspect meters; customer sync setup and review information; customer synch exception setup and review information; device model and meter type setup information; and/or manually re-run device and meter verification information.

The information in the computer/server 426 may be used to generate the proper invoice for the client. The information in the computer/server 426 is updated by the electronic transmission of the meter values in the meter ledger to the billing ledger used to create the bill. As can be seen, in step 428, information about the usage contract and bill schedule setup is extracted from the billings database. In step 430, the device contract start meter setup is identified. In step 432, the usage bill processing is automatically calculated by the system. Only verified valid meters from the meter ledger are used. In step 434, the system considers contract minimums and prior invoices for credits/debits due. In step 436, the usage bill is reviewed by the billing employee as necessary. Any manual overrides are controlled, auditable, reversible and checked by the manager. In step 438, the usage bill is finalized and a summary is emailed to a sales representative. In step 440, the usage bill becomes an invoice and is delivered to the customer. In step 442, the system decides if this a final contract invoice. If, as in step 444, the system determines that this is a final contract invoice, the usage contract is finalized. If, as in step 446, the system determines that this is not the final contract invoice, the next scheduled bill is processed.

As can be seen from the foregoing description, there has been provided a system and a process for reconciling and billing cost per copy contracts and a system and process for synchronizing the data from a meter collection database to a billing database. While the system and process for reconciling and billing cost per copy contracts and the system and process for synchronizing the data from a meter collection database to a billing database has been described in the context of specific embodiments thereof, other unforeseen alternatives, modifications and variations may become apparent to those skilled in the art having read the foregoing description. Accordingly, it is intended to embrace those alternatives, modifications, and variations as fall within the broad scope of the appended claims.

What is claimed is:

1. A process for reconciling and billing cost per copy contracts, said process comprising the steps of:
electronically creating a cost per page contract;
electronically collecting information from meters on devices covered by said contract;
calculating pages printed by each said device from said collected information for a billing period;
comparing calculated printed pages to contracted pages for said billing period;
determining if usage is an overage or an underage; and
creating an invoice if said usage is an overage or creating a credit if said usage is an underage.

2. The process of claim 1, wherein said contract creating step comprises inputting start and end dates and inputting a billing frequency.

3. The process of claim 1, wherein said contract creating step comprises entering pricing information and a number of allotted pages for the billing period.

4. The process of claim 1, further comprising entering information about non-billable meters and devices as exceptions to the contract.

5. The process of claim 1, wherein said collecting information from said meters comprises establishing a baseline meter reading for each said device.

6. The process of claim 5, wherein said collecting information from said meters further comprises reading the meters on said contracted devices at a predetermined interval.

7. The process of claim 5, further comprising calculating an adjusted reading for each said meter which is a projected meter reading for a day that payment of an invoice would be due.

8. The process of claim 7, wherein said calculating step comprises subtracting a number of pages on a previous invoice from said adjusted reading.

9. The process of claim 1, further comprising electronically transmitting said invoice to a customer for approval.

10. The process of claim 9, further comprising designating said invoice as approved if said customer does not approve said invoice within a predetermined period.

11. The process of claim 9, further comprising posting said transmitted invoice to a general ledger in a memory when said invoice is designated as approved.

12. The process of claim 9, further comprising electronically transmitting said invoice to said customer for payment.

13. A process for synchronizing data from a meter collection database to a billing database comprises the steps of:
retrieving a meter value from a device and transmitting the retrieved meter value to a database;
reviewing identifiers associated with the device to determine if the device is a pre-existing device or a new device;
reviewing the meter value to determine that the meter value is valid;
saving said meter value to a meter ledger in said database; and
electronically transmitting said meter value to a billing ledger.

14. The process of claim 13, wherein said identifier reviewing step comprises determining that a customer and a location of said device are active.

15. The process of claim 13, wherein said identifier reviewing step comprises filtering the data to determine that the device is a known model.

16. The process of claim 13, wherein said identifier reviewing step comprises filtering the data to check for customer specific exclusions.

17. The process of claim 13, wherein said identifier reviewing step comprises processing the device as new unless found to be an existing device.

18. The process of claim 13, further comprising creating a new record in said database if said device is determined to be new.

19. The process of claim 13, further comprising retrieving data from each said meter for the last six months.

20. The process of claim 13, wherein said saving step comprises reviewing all meters in said database until all are saved to said meter ledger.

21. The process of claim 13, further comprising marking a record for review if a meter value is determined to be invalid or suspect.

22. The process of claim 13, further comprising electronically generating an invoice for a customer.

23. The process of claim 13, wherein said invoice generating step comprises using information only from verified valid meters.

24. A system for synchronizing data from a meter collection database to a billing database comprising:
a plurality of devices having a meter;
connecting said devices to a processor having a database;
each said device transmitting a meter value to said database;
said processor having means for reviewing identifiers associated with the device to determine if the device is a pre-existing device or a new device, means for reviewing the meter value to determine that the meter value is valid, and means for saving said meter value to a meter ledger in said database; and
a billing ledger for generating invoices to customers, said billing ledger receiving information from said meter ledger.
